(19) United States
(12) Patent Application Publication
(10) Pub. No.: US 2020/0365098 A1
(43) Pub. Date: Nov. 19, 2020

(54) PACKING OF SUBPIXEL RENDERED DATA FOR DISPLAY STREAM COMPRESSION

(71) Applicant: QUALCOMM Incorporated, San Diego, CA (US)

(72) Inventors: Natan JACOBSON, San Diego, CA (US); Ike IKIZYAN, San Diego, CA (US); Daniel STAN, Richmond Hill (CA); Mark STERNBERG, Toronto (CA); Paul Wiercienski, Toronto (CA)

(21) Appl. No.: 16/410,972

(22) Filed: May 13, 2019

(51) Int. Cl. G09G 3/36

(52) U.S. Cl. CPC G09G 3/3607; G09G 3/364

(57) ABSTRACT

A device configured to change a subpixel format from a non-native display device format to a native display format, includes a buffer configured to store compressed pixels in a sub-pixel format that is ordered in the non-native display device format. The device includes a processor, coupled to the buffer, configured to receive, from the buffer, a stream of the compressed pixels, and generate an uncompressed stream of the pixels with a stream compression decoder. The processor is configured to generate an ordered uncompressed stream of pixels in the native display device format by reordering the uncompressed stream of pixels in the sub-pixel format that is ordered in the non-native display format based on a reorder factor that is an integer multiple of a fundamental coding unit used in the stream compression decoder. The processor is configured to output the ordered uncompressed stream of pixels in the native display device format.

### TECHNICAL FIELD

This disclosure is related to pixel packing, more specifically, packing of sub-pixel rendered data for display stream compression.

### BACKGROUND

Display stream compression codecs are designed to compress image data in either the 4:4:4, 4:2:2 or 4:2:0 chroma formats. In general, the display stream compression codecs are optimized for 4:4:4 data in RGB or YUV color-space and 4:2:0/4:2:2 data in YUV color-space.

### SUMMARY

There are various embodiments described herein that include methods for a device that includes a processor configured to change a subpixel format from a non-native display device format to a native display format. The device includes a buffer configured to store compressed pixels in a sub-pixel format that is ordered in the non-native display device format. The device also includes a processor, coupled to the buffer, configured to receive, from the buffer, a stream of the compressed pixels, and generate an uncompressed stream of the pixels with a stream compression decoder. The processor is also configured to generate an ordered uncompressed stream of pixels in the native display device format by reordering the uncompressed stream of pixels in the sub-pixel format that is ordered in the non-native display format based on a reorder factor an integer multiple of a fundamental coding unit used in the stream compression decoder. The processor is also configured to output the ordered uncompressed stream of pixels in the native display device format. In addition, the device includes a reorder buffer, coupled to the processor, configured to store the ordered uncompressed pixels in the sub-pixel format that is ordered in the native display device format.

There are various embodiments described herein that include methods for a device that includes a memory configured to store compressed reordered sub-pixels. The device includes a processor configured to sub-sample a stream of uncompressed pixels into different color components to generate a plurality of sub-pixels for each uncompressed pixel. The processor is also configured to reorder, the sub-pixels of each uncompressed pixel, in a reorder buffer, based on a reorder factor that is an integer multiple of a fundamental coding unit used in stream compression encoder. In addition, the processor is configured to compress the reordered sub-pixels using a stream compression encoder, and, store the compressed reordered sub-pixels to the memory. The device also includes a memory configured to store compressed reordered sub-pixels.

There are various embodiments described herein that include a method for storing compressed pixels in a sub-pixel format that is ordered in a non-native display device format into a buffer. The method includes receiving, from the buffer, a stream of the compressed pixels in the sub-pixel format ordered in the non-native display device format. The method also includes generating an uncompressed stream of pixels in the sub-pixel format that is ordered in the non-native display device format with a stream compression decoder. Moreover, the method includes generating an ordered uncompressed stream of pixels in the native display device format by reordering the uncompressed stream of pixels in the sub-pixel format that is ordered in the non-native display format based on a reorder factor an integer multiple of a fundamental coding unit used in the stream compression decoder. In addition, the method includes storing the ordered uncompressed stream of pixels in the sub-pixel format that is ordered in the native display device format.

There are various embodiments described herein that include a method of sub-sampling a stream of uncompressed pixels into different color components to generate a plurality of sub-pixels for each uncompressed pixel. The method includes reordering the sub-pixels of each uncompressed pixel, in a reorder buffer, based on a reorder factor that is an integer multiple of a fundamental coding unit used in stream compression encoder. The method includes compressing the reordered sub-pixels using a stream compression encoder. The method also includes outputting the compressed reordered sub-pixels.

There are various embodiments described herein that include an apparatus that includes means for storing compressed pixels in a sub-pixel format that is ordered in a non-native display device format into a buffer. The apparatus includes means for receiving, from the buffer, a stream of the compressed pixels in the sub-pixel format ordered in the non-native display device format. The apparatus also includes means for generating an uncompressed stream of pixels in the sub-pixel format that is ordered in the non-native display device format with a stream compression decoder. Moreover, the apparatus includes means for generating an ordered uncompressed stream of pixels in the native display device format by reordering the uncompressed stream of pixels in the sub-pixel format that is ordered in the non-native display format based on a reorder factor that is an integer multiple of a fundamental coding unit used in the stream compression decoder. In addition, the apparatus includes means for storing the ordered uncompressed stream of pixels in the sub-pixel format that is ordered in the native display device format.

There are various embodiments described herein that include a non-transitory computer-readable storage medium having stored thereon instructions that, when executed, cause a processor of a device to receive, from a buffer, a stream of the compressed pixels, and generate an uncompressed stream of the pixels with a stream compression decoder. The instructions, when executed, cause the processor to generate an ordered uncompressed stream of pixels in the native display device format by reordering the uncompressed stream of pixels in the sub-pixel format that is ordered in the non-native display format based on a reorder factor that is an integer multiple of a fundamental coding unit used in the stream compression decoder. The instructions, when executed, cause the processor to output the ordered uncompressed stream of pixels in the native display device format.

There are various embodiments described herein that include an apparatus that includes means for sub-sampling a stream of uncompressed pixels into different color components to generate a plurality of sub-pixels for each uncompressed pixel. The apparatus includes means for reordering the sub-pixels of each uncompressed pixel, in a reorder buffer, based on a reorder factor that is an integer multiple of a fundamental coding unit used in stream compression encoder. The apparatus includes means for compressing the reordered sub-pixels using a stream compression encoder. The apparatus also includes means for outputting the compressed reordered sub-pixels.

There are various embodiments described herein that include a non-transitory computer-readable storage medium having stored thereon instructions that, when executed, cause a processor of a device to sub-sample a stream of uncompressed pixels into different color components to generate a plurality of sub-pixels for each uncompressed pixel. The instructions, when executed, cause the processor to reorder, sub-pixels of each uncompressed pixel, in a reorder buffer, based on a reorder factor that is an integer multiple of a fundamental coding unit used in stream compression encoder. In addition, the instructions, when executed, cause the processor to compress the reordered sub-pixels using a stream compression encoder, and, store the compressed reordered sub-pixels to a memory.

### BRIEF DESCRIPTION OF THE DRAWINGS

FIG. 1A illustrates an example of a Full Stripe RGB subpixel format.

FIG. 1B illustrates an example of a Pen Tile subpixel format.

FIG. 1C illustrates an example of a GGRB subpixel format.

FIG. 1D illustrates an example of a Delta-Type-1 subpixel format.

FIG. 1E illustrates an example of a Delta-Type-2 subpixel format.

FIG. 1F illustrates an example of a RGBW subpixel format.

FIG. 2 illustrates different examples of data flow between a display core, display driver integrated circuit, and panel.

FIG. 3A illustrates an example of a reorder buffer configured to modify a pixel stream and reorder the subpixels in the pixel stream from a native format to a non-native format.

FIG. 3B illustrates an example of a reorder buffer configured to modify a pixel stream and reorder the subpixels in the pixel stream from a non-native format to a non-native format.

FIG. 4 illustrates different results for different reorder factors of 4:4:4 packing for Pen Tile type data, where odd columns may be reordered, and an alternative implementation.

FIG. 5 illustrates comparisons of different reorder factors for an example image.

FIG. 6 illustrates different results for different reorder factors using a reordering technique for RGBW data, and an alternative implementation.

FIG. 7A illustrates a flowchart of a process of a device that includes a reorder buffer based on a reorder factor in accordance with the techniques disclosed herein.

FIG. 7B illustrates a flowchart of a process of a device that changes a subpixel format from a non-native display device to a native display format in accordance with the techniques disclosed herein.

FIG. 8A illustrates the performance of 4:4:4 packing for the DSC codec using 8 bits per color (bpc).

FIG. 8B illustrates the performance of 4:2:2 packing for the DSC codec using 10 bpc.

FIG. 9A illustrates the performance of 4:4:4 packing and 4:2:2 packing for the VDC-M codec using 8bpc.

FIG. 9B illustrates the performance of the performance of 4:4:4 packing and 4:2:2 packing for the VDC-M codec using 10 bpc.

FIG. 10 illustrates for both display stream compression codecs, the performance for RGBW data, 4:4:4 packing.

### DETAILED DESCRIPTION

Subpixel Rendering (SPR)

A pixel on a color display can be made up of three different colors: red, green, and blue. The number of colors in an image that may be displayed is determined by color depth. Color depth is expressed in bits per color (bpc). Monitors may support 24-bit true color, i.e., 8 bits per color channel. That is to say there are 8 bits of a channel for the red color component, 8 bits of a channel for the green color component, and 8 bits of a channel for the blue color component. Displays that display more than 8 bpc have a higher color depth which allows for more vibrant images. Some displays may have pixels that also are made up by yellow, cyan. The colors of the pixels are often times referred to as subpixels. Subpixels appear as a single color to the human eye. Subpixel rendering may be more appropriate for certain display technologies, e.g., liquid crystal displays (LCDs) or organic light emitting diodes (OLEDs). Modern displays may use one of many different subpixel formats, depending on the display type and manufacturer.

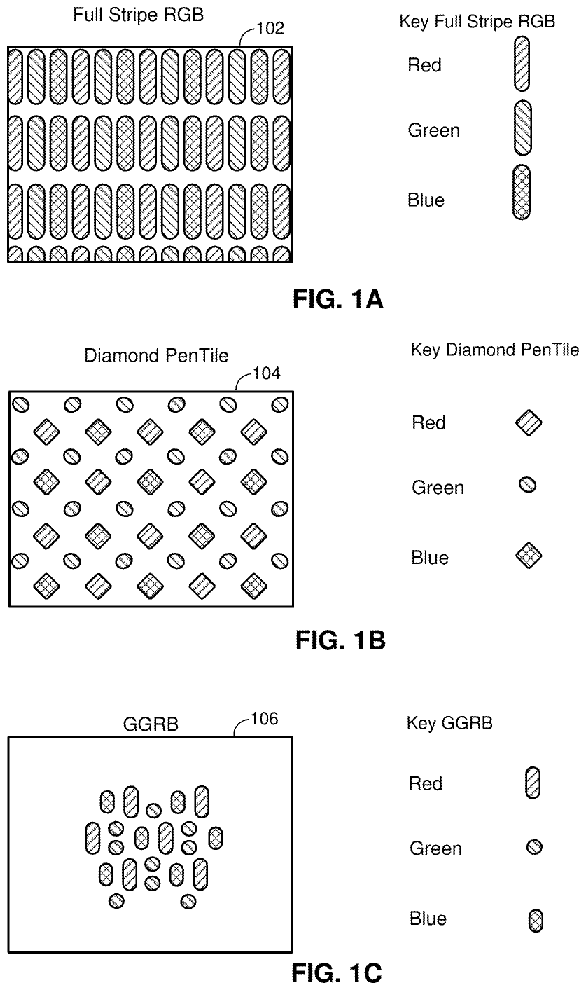

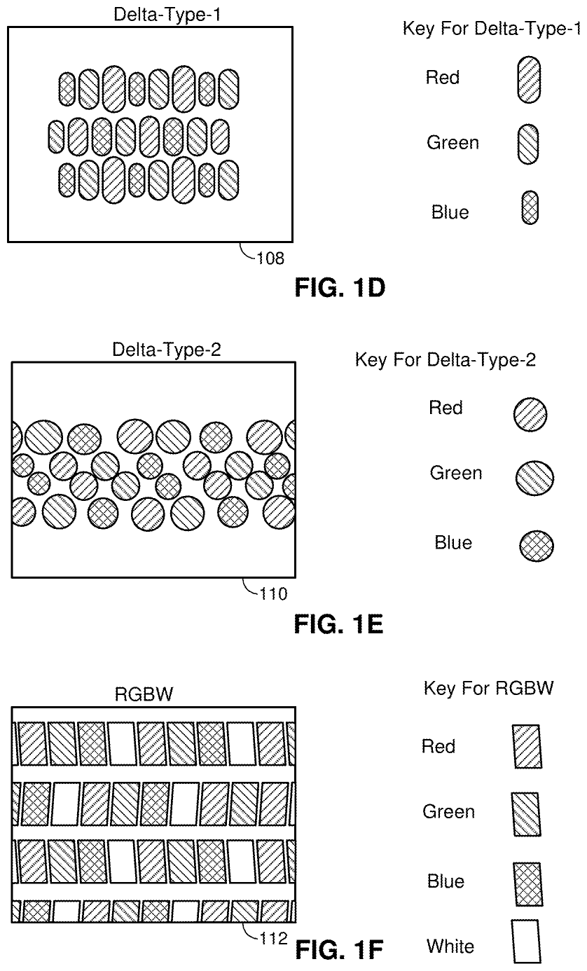

FIG. 1A illustrates an example of a Full Stripe RGB subpixel format 102. FIG. 1B illustrates an example of a Pen Tile subpixel format 104. FIG. 1C illustrates an example of a GGRB subpixel format 106. FIG. 1D illustrates an example of a Delta-Type-1 subpixel format 108. FIG. 1E illustrates an example of a Delta-Type-2 subpixel format 110. FIG. 1F illustrates an example of a RGBW subpixel format 112.

The subpixel formats in FIG. 1A-1F may be referred to as native subpixel formats if a panel has been designed to display the native subpixel formats on a panel (e.g., a screen) in the same order as the subpixel formats stored in the memory accessed prior to displaying on the panel. A non-native subpixel format represents the scenario when the subpixels accessed in the memory prior to displaying on the panel are ordered in a different order as the subpixel format for which the panel has been designed to display.

Full Stripe RGB format 102 in FIG. 1A in which each display pixel consists of one red, one green and one blue subpixel. The Full Stripe RGB format 102 is an exemplary format that may be used in LCD's. For OLED displays, the complicated circuitry required for each subpixel makes the Full Stripe RGB format 102 infeasible using current process technology. Many alternative subpixel structures have been proposed and are currently being used in existing products. The main types of subpixel rendering for OLED displays are Pen Tile type data, including the Diamond Pen Tile subpixel format 104 in FIG. 1B, the Delta-Type-1 subpixel format 106 in FIG. 1C, and the Delta-Type-2 subpixel format 108 in FIG. 1D.

For Pen Tile subpixel formats including the Diamond Pen Tile subpixel format 104 in FIG. 1B, the green component is unaltered (i.e., there is one green subpixel for each pixel in the source image). The red (R) and blue (B) components may be subsampled by a factor of 2:1 (i.e., there is one red/blue subpixel for each two red/blue pixels in the source image).

For the Delta-Type 1 subpixel format 106 in FIG. 1C, the red, green and blue components may be subsampled by a factor of 3:2. The Delta-Type-1 subpixel format 108 in FIG. 1D, and the Delta-Type-2 subpixel format 110 in FIG. 1E may be used by panel manufacturers in China.

An alternative subpixel structure used for LCD displays is the RGBW (RGB+White) subpixel format 112 in FIG. 1F. The addition of the white (W) subpixel in the R component allows for a higher display luminance at the expense of color accuracy.

Problems

Display stream compression codecs are designed to compress image data in either the 4:4:4, 4:2:2 or 4:2:0 chroma formats. In general, these codecs are optimized for 4:4:4 data in RGB or YUV colorspace and 4:2:0/4:2:2 data in YUV colorspace. Subpixel rendering produces display streams which do not easily conform to these formats, which may cause a loss of performance in the codec. For example, Pen Tile type data is 4:2:2/RGB while RGBW data has four color components.

In this disclosure, methods of packing subpixel-rendered data for use in a display system utilizing display stream compression are described. This allows for optimized performance while also reducing system cost and power by migrating features from the DDIC to the display core. In addition, the proposed methods may be used to support Pen Tile type data and RGBW data on a DSC v1.1 core.

Display Stream Compression

As display resolutions increase, visually lossless display stream compression is being utilized more frequently to reduce transmission link bandwidth. This is true for low-bandwidth mobile links such as MIPI Display Serial Interface (DSI). As an example, consider a display resolution of 2960×1440 at 24 bits/pixel and 60 frames/second. The required bandwidth for this link is:

2960*1440*24*60=6.14 gbit/sec.

This exceeds the typical 1 GHz MIPI DSI transmission link capacity of 4 gbit/sec. However, if display stream compression is used at a rate of 6 bits/pixel, then the required bandwidth becomes:

2960*1440*6*60=1.53 gbit/sec.

This may enable the required transmission over an existing link. The two available standards for display stream compression are given in the following subsections.

Stream Compression Codecs

The Video Electronics Standards Association (VESA) Display Stream Compression (DSC) codec was standardized in 2014 as the first VESA codec for display streams. This codec supports visually lossless compression down to 8 bits/pixel. The version history is as follows. DSC v1.0: deprecated. In DSC v1.1: currently active, supporting compression of 4:4:4 pictures only. In DSC v1.2: currently active, adding support for 4:2:0/4:2:2 chroma formats. The fundamental unit of compression for DSC is a 3×1 “group.” To optimize performance, data within a group should be spatially correlated. The DSC encoder is an example of a stream compression encoder, and the DSC decoder is an example of a stream compression decoder.

VDC-M Codec

The VESA Display Compression-M (VDC-M) codec was standardized in 2018 as the second VESA codec for display streams. This codec supports visually lossless compression down to 6 bits/pixel. The version history is as follows: VDC-M v1.0: deprecated. VDC-M v1.1: currently active, supporting compression of 4:2:0/4:2:2/4:4:4 pictures. The fundamental unit of compression for VDC-M is an 8×2 “block.” To optimize performance, data within a block should be spatially correlated.

A reorder factor represents the number of subpixels in a pixel stream of the same color component that are grouped together before a different group of subpixels of the same color component are grouped together and should be an integer multiple of the fundamental coding unit size of a compression codec.

There are at least two display stream compression codecs that may benefit from using a reorder factor: (1) VESA DSC codec; and (2) VESA VDC-M codec. The fundamental coding unit is a group size of 3 subpixels for a display stream compression (DSC) codec. The fundamental coding unit is a block size of 8×2 subpixels for a VESA display compression-M (VDC-M) codec.

It is desirable for the reorder factor to be an integer multiple of the fundamental coding unit size of a compression codec. For example, if “Full Stripe” data (4:4:4) is being processed, then a DSC codec group will have 3 pixels, which will be 9 total subpixels (3 red, 3 green, 3 blue). Each “group” in the DSC codec consists of 3 full pixels. As the DSC codec employs sub-stream multiplexing, the DSC codec processes the 3 red, 3 green and 3 blue samples in parallel, such that all occur during the group time.

Similarly, to how there are a “group” of 3 pixels for the DSC codec to process, a VDC-M codec processes a “block” of 8×2 pixels. Thus, the VCM-M codec processes the 16 red, green and blue samples for a block during the same “block time.” It is important that all the samples within a group (DSC codec) or block (VDC-M codec) have high spatial correlation so that the compression efficiency is maximized.

This is the reason why it is desirable for the reorder factor to be an integer multiple of the fundamental coding unit size with the group size of a DSC codec or with the block size of the VDC-M codec. The VDC-M encoder is an example of a stream compression encoder, and the VDC-M decoder is an example of a stream compression decoder.

In the last 15+ years, displays have improved in terms of spatial resolution and refresh rates. These improvements support a better experience in gaming and virtual reality. In addition, the recent availability of High Dynamic Range (HDR) content has necessitated an increase in bit-depth to support new transfer functions such as PQ/ST.2084 and Hybrid Log Gamma (HLG).

These increases in pixel bandwidth have necessitated the use of display stream compression to support higher bandwidth across existing display links. The DSC standard has seen rapid market adoption for visually lossless compression of display streams for televisions and computer monitors using DisplayPort (v1.4+) connectors. In addition, the MIPI Display Serial Interface (DSI) v1.2 has adopted DSC v1.1 for mobile display links. Due to the continued increase in pixel bandwidth, especially for mobile displays and VR, VESA developed the VDC-M codec. The VDC-M codec supports a compressed bitrate down to 6 bits/pixel (bpp) for 4:4:4 content with visually lossless quality for difficult content. In addition to easing bandwidth constraints, VDC-M may allow for smaller frame buffer memory on the display driver IC (DDIC), reducing system cost.

The reorder factor should be a multiple of the fundamental coding unit size for one or both codecs to obtain optimal results with respect to the display stream compression codecs.

Display Pipeline

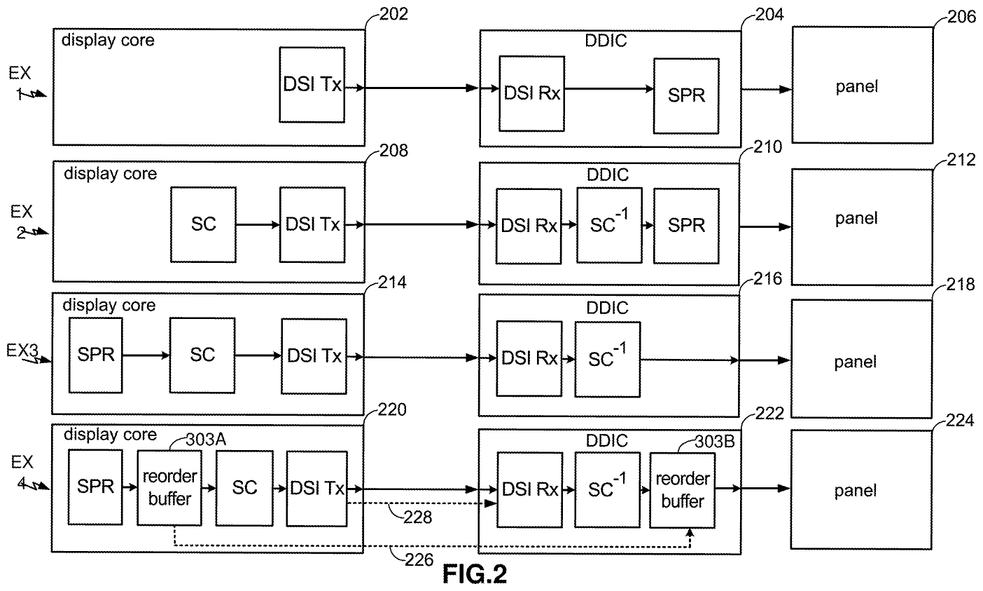

FIG. 2 illustrates four different examples (EX1-EX4) of data flow between a display core, display driver integrated circuit, and panel. Each Example (EX) is a row in FIG. 2. Subpixel rendering (SPR) may be performed at either the display driver IC (DDIC) or the display core in an application processor. As such, a display driver may be integrated with a processor. The four examples (EX1-EX4) of a system utilizing combinations of sub-pixel rendering (SPR) and compression are shown in FIG. 2. As can be seen from FIG. 2, the display core and DDIC may perform various operations to convert a non-native display device format to a native display format.

In the first example (EX1) illustrating a display core 202, a DDIC 204, and panel 206, the display data over a digital serial interface (DSI) (or could be other type of serial interface) is transmitted uncompressed to the DDIC 204 from the display core 202. The DDIC computes the SPR data and sends it to the panel 206. The SPR data converts the non-native subpixel format output from the DSI and converts into a native subpixel format of the panel 206. This system, in the first example (EX1), requires maximum transmission bandwidth and the SPR calculation on DDIC may be expensive from a power standpoint.

In the second example (EX2) illustrating a display core 208, a DDIC 210, and panel 212, the display core 208 compresses the display data using a Stream Compression (“SC”) encoder and produces a compressed bitstream. The SC encoder may be either a DSC encoder or a VDC-M encoder. The DSI Tx block transmits the bitstream. The DSI Rx receives the compressed bitstream and passes it to the inverse SC (SC⁻¹) block which uncompresses the received bitstream. SPR is performed on the uncompressed bitstream in the DDIC 210. The SPR data is then provided to the panel 212. The uncompressed data is in a non-native subpixel format. As in example 1 (EX1), the SPR data converts the non-native subpixel format output from the DSI and converts into a native subpixel format of the panel 206. This system, in the second example (EX2), reduces transmission bandwidth, as the data was compressed using the SC, but still has increased DDIC 204 power consumption.

In the third example (EX3) illustrating a display core 214, a DDIC 216, and panel 218, SPR is in a native subpixel format and is computed at the display core 214. The native subpixel format is compressed by an SC encoder (e.g., by either a DSC encoder or VDC-M encoder). The compressed bitstream is transmitted by the DSI Tx block in the display core 214. The compressed bitstream is received by the DSI Rx block in the DDIC 216. The compressed bitstream is uncompressed by the inverse SC (SC⁻¹) block, i.e., a stream compression decoder (e.g., a DSC decoder or VDC-M decoder). The uncompressed bitstream is provided to the panel 218 to be displayed. This system, in the third example (EX3), reduces transmission bandwidth and DDIC power. This system, in the third example (EX3), is advantageous for Pen Tile type data using 4:2:2 packing and delta-type data using 4:4:4 packing (i.e. where no reorder buffer is required).

In the fourth example (EX4) illustrating a display core 220, a DDIC 222, and panel 224, SPR is in a native subpixel format and is computed at the display core 220. Unlike, the third example (EX3), the native subpixel format output from the SPR is reordered by the reorder block 303A to optimize performance of the stream codec (i.e., the SC encoder and SC decoder). As such, the output of the reorder block 303A, the reordered SPR data, is in a non-native subpixel format. The reordered SPR data in the display core 220 is sent to the SC encoder (e.g., either a DSC encoder or VDC-M encoder) which produces a compressed bitstream. The compressed bitstream is sent by the DSI Tx block to the DDIC 222. The DSI Rx block receives the compressed bitstream. The compressed bitstream is uncompressed by the inverse SC (SC⁻¹) block, i.e., a stream compression decoder (e.g., a DSC decoder or VDC-M decoder), and reordered back, via the reorder buffer 303B, to the initial order (i.e., the native subpixel format) output of the SPR in the display core 220. The uncompressed bitstream is provided to the panel 224 to be displayed.

This system, in the fourth example (EX4), is advantageous for Pen Tile type data and RGBW data using 4:4:4 packing. The use of the reorder buffers 303A, 303B helps to improve visual quality after encoding and decoding, through the stream encoder and stream decoder. The reordering aids in having regions of correlated data such that the codec(s) can perform better with respect to visual quality. As an example, a video encoder only aware of color components [R, G, B] will “interpret” the W subpixel as being a red subpixel if RGBW data is sent to the video encoder directly without reordering. In the case where the video encoder is a DSC encoder, the first “group” for the red color component would contain the following actual subpixel values: [R, W, B], for which spatial correlation may be minimal, and thus not desirable. To compensate for such undesirable result, a reordering is used. As an example, consider a reorder factor of 3. The reorder factor of 3 allows for the first “group” of the red color component to contain [R, R, R], where R is the color red. As a result, the performance with respect to visual quality (after decoding) will be improved.

Though a VR headset is capable of receiving digital streams, it is contemplated in this disclosure that in the future, VR headsets may also be able to broadcast or unicast digital streams, i.e., transmit digital streams. As such, a display core 220 may be included in a VR headset.

Moreover, VR headsets, as well as, televisions, smartphones, display devices in vehicles, laptops, or some other device are capable of receiving streaming content. As such, any of these devices may include a digital driver integrated circuit 222, and a panel 224. Theses device, e.g., a smartphone, a television, a display device, a laptop, or a VR headset, are examples of devices that may be configured to change a subpixel format from a non-native display device format to a native display format. An efficient way for Pen Tile type data and RGBW data using 4:4:4 packing is to use reorder buffers as outlined in the fourth example (EX4) of FIG. 2. For example, a reorder buffer 303A in the display core 220 may be used. In addition, a reorder buffer 303B in the digital driver integrated circuit 222 may also be used.

Reorder Buffer

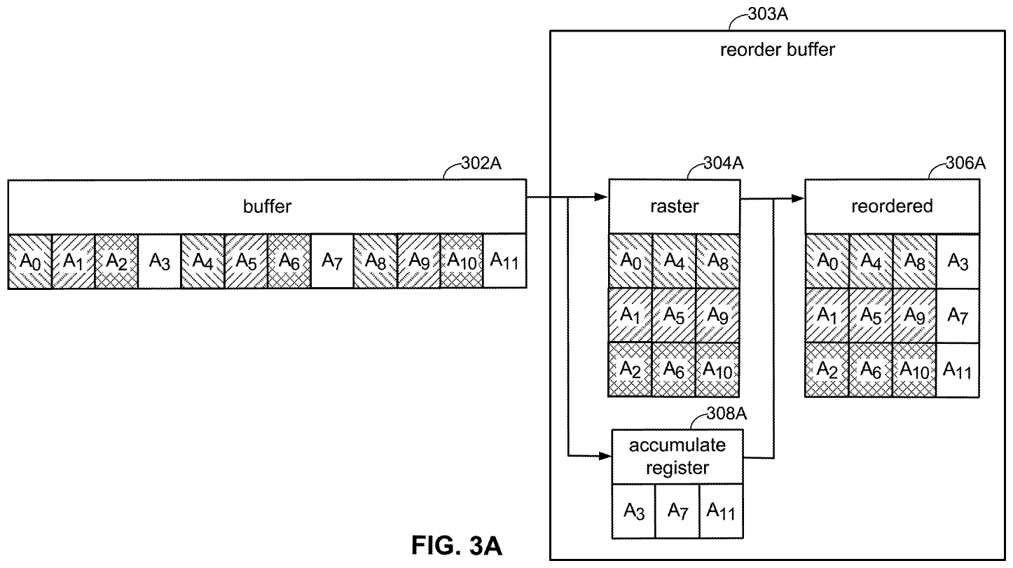

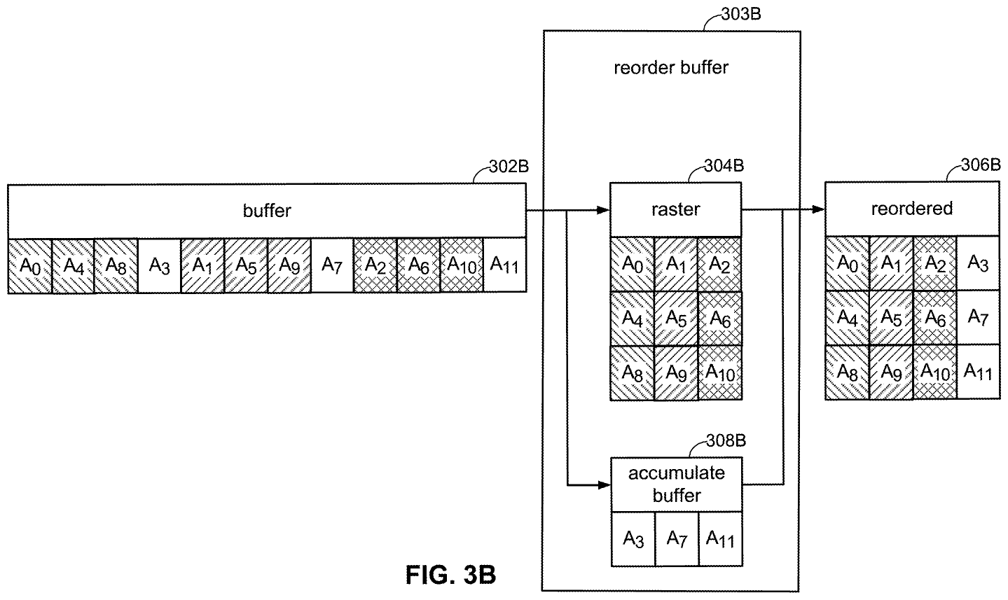

FIG. 3A illustrates an example of a reorder buffer configured to modify a pixel stream and reorder the subpixels in the pixel stream from a native format to a non-native format. Some of the methods discussed in this disclosure rely on a reorder buffer 303A to modify the pixel stream in the buffer 302A. A pixel may be represented by three subpixels, where each subpixel represents a color component. A reorder buffer 303A may, for example, store samples. A sample may be used to represent a subpixel. For example, every three subpixels (e.g., A₀, A₁, A₂) in the buffer 302A represent three samples. Inside or outside of the reorder buffer a controller (not shown) may raster scan the input stream in the buffer 302A, and produce a raster stream 304A, and store the sub-pixels according to a color. The controller may be part of a processor and may be integrated with a reorder buffer 303A either inside of it or outside of it. For example, subpixels A0, A4, and A8 may all be the same color (e.g., red, green or blue). The reorder buffer 303A may also include an accumulate register that accumulates every Nth sample. The register may also be a buffer, and, may in some implementations be referenced as an accumulate buffer.

In the example of FIG. 3A, the accumulate register may store every 4^{th} subpixel from the input pixel stream. Once there are three sub-pixels in the accumulate register, the three sub-pixels may be joined with the other sub-pixels. Thus, the controller that is part of the processor may perform functions (e.g., raster and accumulate) on the input stream of pixels (or if referring to each color component as the stream of sub-pixels, though “stream” is understood by a persona of having ordinary skill in the art as being associated with pixels) in the buffer 302A, and, store them as reordered pixels in the reordered section306A. The pixels may be also referred to as reordered subpixels if referring to each color component of the reordered section 3036A.

When the reorder buffer 303A has accumulated three ‘fourth’ samples, the three samples (i.e., subpixels) are appended into the raster stream 304A as a fourth column (in this example). For example, illustrated in FIG. 3A every fourth sample is placed into the reorder buffer 308A is A3, A7, and A11. The collection of A3, A7, and A11 represents the accumulated three ‘fourth’ samples that are joined into the raster stream 304A as the fourth column. The output of the reorder buffer 303A that is appended into the raster stream 304A produces a reordered pixel stream in the reordered section 306A of the reordered buffer 303A.

There is a reorder factor (RF) that is the size of the reorder buffer. That is to say, as the reorder factor represents the number of subpixels in a pixel stream of the same color component that are grouped together before a different group of subpixels of the same color component are grouped together, one can see in FIG. 3A that every group of subpixels in the accumulate buffer includes 3 subpixels. A new row in the reordered section 306A of the reordered buffer 303A includes a different group of subpixels of the same color component. Thus, in the example in FIG. 3A, the RF is equal to three.

Generalizing, the reorder buffer requirement is the reorder factor times the number of bits for each subpixel. For example, if RF=24 and subpixels are 10 bits each (i.e., 10 bpc), then the reorder buffer should be at least 240 bits in size. If subpixels were 8 bitt each (i.e., 8 bpc), then the reorder buffer should be at least 184 (24*8) bits in size.

The SPR in the display core 220 (of FIG. 2) may operate on a non-native display device format, and the output of the SPR may be a native display device format. A device that includes a display core 220 that is integrated into a processor included in a device that streams digital content, may be configured to sub-sample a stream of uncompressed pixels into different color components, and generate a plurality of sub-pixels for each uncompressed pixel, wherein each sub-pixel is represented by one color component. The input pixel stream in the buffer 302A, for example, is a plurality of sub-pixels for each uncompressed pixel, wherein each sub-pixel is represented by one color component. Thus, the input stream 302A may represent a native display device format.

However, for power efficiency and compression efficiency, the native display device format may be reordered by a reorder buffer 303A. The increase in power efficiency is derived from the fact that without the reorder buffer 303A, stream compression using a DSC codec (encoder and decoder) or VDC-M codec (encoder and decoder) may not be feasible due to reduction in visual quality previously described. The reorder buffer 303A, integrated with the processor in the display core 220 may be configured to reorder, the sub-pixels of each uncompressed pixel in a reorder buffer, based on a reorder factor that is an integer multiple of a fundamental coding unit used in a stream compression codec. The SC codec, which may also be integrated into the processor in the display core 220 may be configured to compress the reordered sub-pixels using the stream compression codec.

In addition, there may be a digital serial interface (DSI Tx) that is integrated into the processor in the display core 220 that is configured to output the compressed reordered sub-pixels. In some embodiments, there may be a transmitter that is configured to transmit the compressed reordered sub-pixels over the air (i.e., stream the video content). In some embodiments, the display core 220, integrated into a processor may be configured to output metadata 228 that includes the reorder factor and the fundamental coding unit. In other embodiments, the display core 220, integrated into a processor may be configured to output a set of bits, in a bitstream 226, representing the reorder factor and the fundamental coding unit. In other embodiments, the fundamental coding unit is implicit in the design.

By outputting the reorder factor, the device that receives the streaming content, may use the reorder factor, whether received via metadata 228 or signaled as part of the bitstream 226, e.g., in a header. As a result, the device that receives the reorder factor and streaming content may produce a sub-pixel format that is ordered in a native display device format.

The digital display integrated circuit (DDIC) 222 may be integrated into a device that receives the streaming content. That is to say, the DDIC 222 may be integrated into a device configured to change a subpixel format from a non-native display device format to a native display format. The DDIC 222 may be coupled to a panel 224, and both the DDIC 222 and panel 224 may be included as part of a display device. For example, the streamed content may be received by a digital serial interface (DSI Rx) which may be coupled to a buffer (not shown). The device may also include a buffer configured to store compressed pixels in a sub-pixel format that is ordered in a non-native display device format. The order of the subpixels may be modified to increase performance through the stream compression codec (either with a DSC codec or a VDCM-codec). After the DDIC 222 decodes the data, a reorder using the reorder buffer 303B will be required to bring the subpixels back to the “native format.” The DDIC 222 may be integrated to a processor that is coupled to the buffer.

Moreover, the processor that includes the DDIC 222 may be configured to receive, from the buffer, a stream of the compressed pixels in the sub-pixel format ordered in the non-native display device format, and, generate an uncompressed stream of pixels in the sub-pixel format that is ordered in the non-native display device format with a stream compression decoder. For example, the stream compression decoder may be the inverse SC (SC⁻¹) block, i.e., a stream compression decoder (e.g., a DSC decoder or VDC-M decoder). The stream compression decoder, which may be integrated into the processor that includes the DDIC 222. The processor that includes the DDIC 222 may be configured to generate an ordered uncompressed stream of pixels in a native display device format by reordering the uncompressed stream of pixels in the sub-pixel format that is ordered in the non-native display format. The reordering of the uncompressed stream may be based on a reorder factor that is an integer multiple of a fundamental coding unit used in the stream compression decoder.

The processor that includes the DDIC 222 may be configured to output, to a reorder buffer, the ordered uncompressed stream of pixels in the native display device subpixel format. In addition, the device that is configured to change a subpixel format from a non-native display device format to a native display format, may include a reorder buffer 303B coupled to the processor that includes the DDIC 222, configured to store the ordered uncompressed pixels in the sub-pixel format that is ordered in a native display device format. As such, the reorder buffer 303B may be configured to reorder the sub-pixels back to the initial order after the SPR in the display core 220, or some other equivalent from a streaming device. Thus, an uncompressed bitstream which includes the sub-pixels in the native display device format may be provided to the panel 224 to be displayed.

In addition, the device may include a processor that is configured to receive metadata 228 that includes the reorder factor. Alternatively, the device may include a processor that is configured to receive a set of bits, in a bitstream 226, representing the reorder factor.

4:4:4 Packing for Pen Tile Type Data

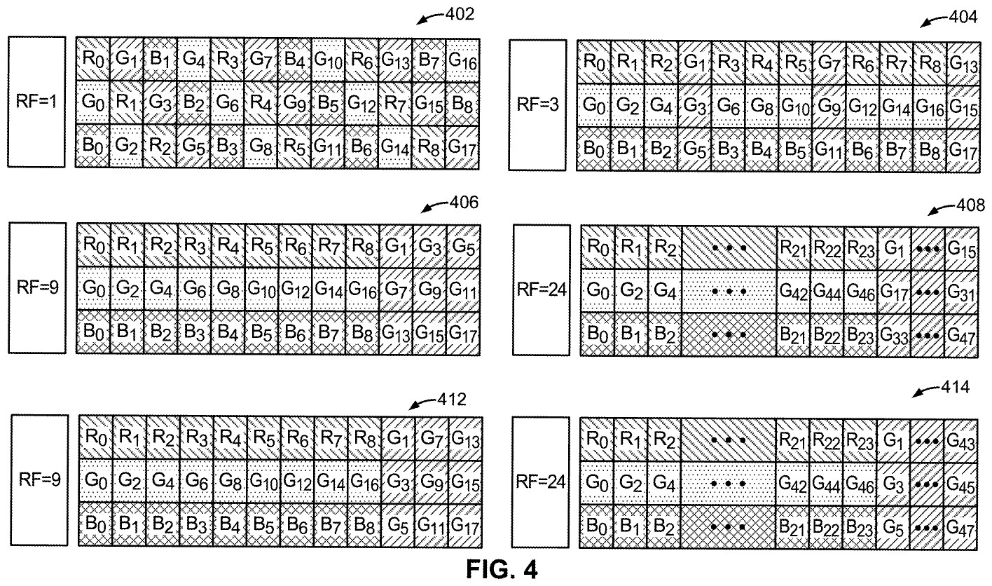

FIG. 4 illustrates different results for different reorder factors of 4:4:4 packing for Diamond Pen Tile type data, where odd columns may be reordered, and an alternative implementation. The 4:4:4 packing for Diamond Pen Tile type data packing method uses a reorder buffer to split the green component between even and odd columns. Even columns may enter the raster, while odd columns may be reordered. By effectively subsampling the green component by a factor of 2:1, the RGB may be spatially consistent. In FIG. 4, examples of different reorder factors using this packing method are shown. A reorder factor equal to one represents that reordering was performed by the reorder buffer in FIG. 3A or the reorder buffer in FIG. 3B. The resulting reordered subpixels 402 are shown in the upper left of FIG. 4. The resulting reordered subpixels 404 are shown in the upper right of FIG. 4 using a reorder factor of 3 for the reorder buffer in FIG. 3A. The resulting reordered subpixels 406 are shown in the middle left of FIG. 4 using a reorder factor of 9 for the reorder buffer in FIG. 3A. The resulting reordered subpixels 408 are shown in the middle right of FIG. 4 using a reorder factor of 24 for the reorder buffer in FIG. 3A. The resulting reordered subpixels 410 are shown in the lower left of FIG. 4A using a reorder factor of 9 for the reorder buffer in FIG. 3A with an alternative packing method. The resulting reordered subpixels 412 are shown in the lower right of FIG. 4 using a reorder factor of 24 for the reorder buffer in FIG. 3A with an alternative packing method.

A major benefit of the 4:4:4 packing for Pen Tile type data is as an alternative to 4:2:2 packing (see next section) for Pen Tile type data. For example, this may allow the application processor to use the DSC codec using the DSC v1.1 standard in 4:4:4 mode and remove the requirement of updating to a more expensive DSC v1.2 encoder (which supports native 4:2:2 mode). The additional cost of the reorder buffer is small in comparison to a DSC codec using the DSC v1.2 standard core, which is 33% larger than a DSC codec using the DSC 1.1 standard core.

In contrast, a VDC-M codec in using the VDC-M v1.1 standard core supports all chroma formats natively, so the choice of 4:2:2/4:4:4 packing may be made by a system designer.

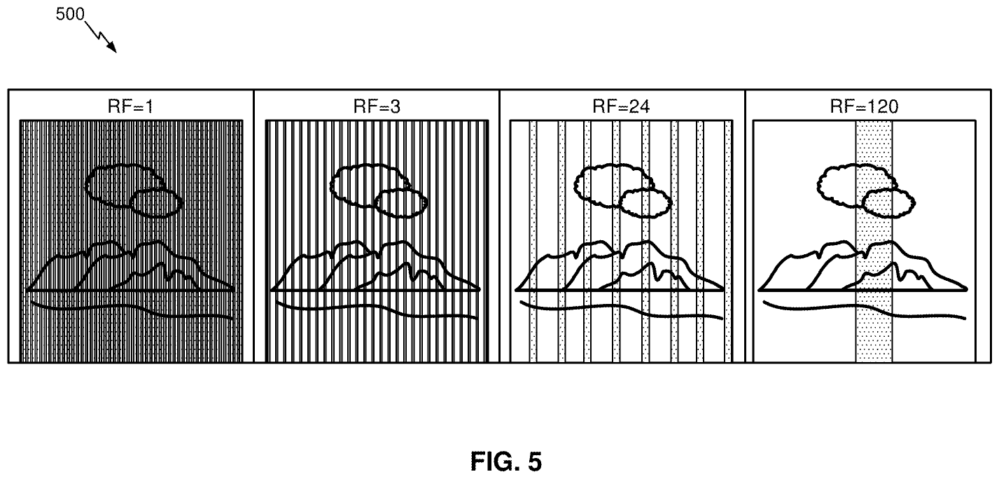

FIG. 5 illustrates comparisons 500 of different reorder factors (RF=1, RF=3, RF=24, RF=120) for an example image.

The example image is a Pen Tile type subpixel format and reordering were performed such that 4:4:4 packing can be utilized. The reordering in this example effectively splits the green component into even and odd columns. The green even columns are grouped with red and blue data to produce spatially-correlated RGB data. The green odd columns are grouped together by way of the reorder buffer. As the reorder factor increases from 1 to 120, the reordered image will contain larger and larger “stripes” of correlated data, which will improve the both the DSC codec and VDC-M codec' s performance.

4:2:2 Packing for Pen Tile Type Data

When using the VDC-M v1.1 standard and the DSC v1.2 standard, the native 4:2:2 mode of the display stream compression codec can be used directly for Pen Tile type data. The green component is mapped to the luminance component (0) while the red and blue components are mapped to the chrominance components (1, 2).

4:4:4 Packing for RGBW Data

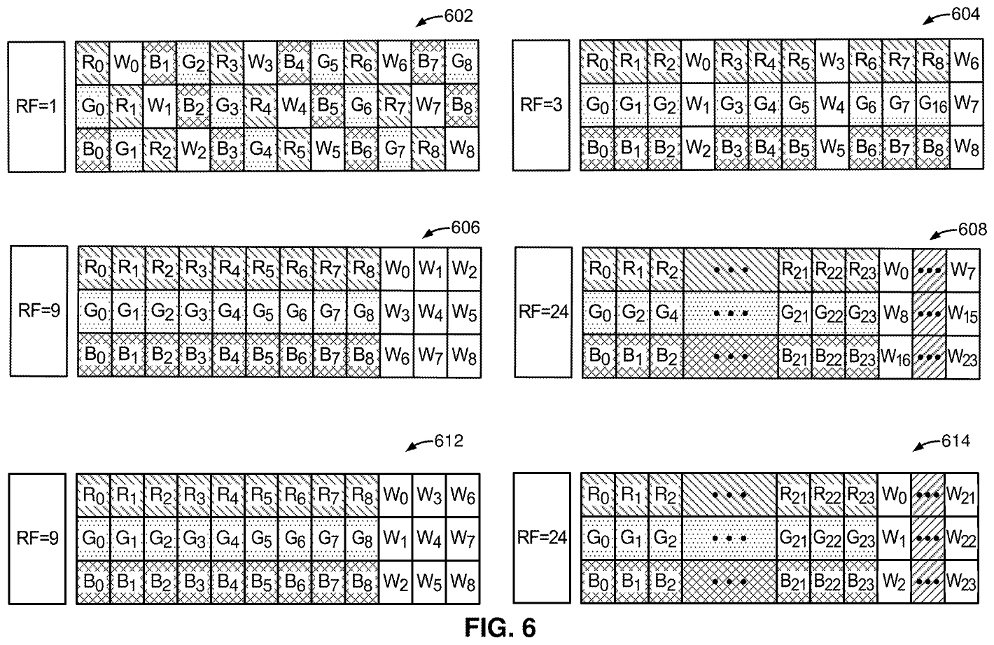

FIG. 6 illustrates different results for different reorder factors using a reordering technique for RGBW data, and an alternative implementation. A similar reordering technique may be used for RGBW data as was used for 4:4:4 Pen Tile type data. Instead of splitting the green component by even/odd columns, the RGB components can be used directly while the white component may fill the reordered sample positions, as shown in Error! Reference source not found. The resulting reordered subpixels 602 are shown in the upper left of FIG. 6 using a reorder factor of 1. The resulting reordered subpixels 604 are shown in the upper right of FIG. 6 using a reorder factor of 3 for the reorder buffer in FIG. 3A or FIG. 3B. The resulting reordered subpixels 606 are shown in the middle left of FIG. 6 using a reorder factor of 9 for the reorder buffer in FIG. 3A. The resulting reordered subpixels 608 are shown in the middle right of FIG. 6 using a reorder factor of 24 for the reorder buffer in FIG. 3A or FIG. 3B. The resulting reordered subpixels 610 are shown in the lower left of FIG. 6 using a reorder factor of 9 for the reorder buffer in FIG. 3A or FIG. 3B with an alternative packing method. The resulting reordered subpixels 612 are shown in the lower right of FIG. 6 using a reorder factor of 24 for the reorder buffer in FIG. 3A or FIG. 3B with an alternative packing method.

For a fair comparison, the different packing methods are ordered by the compression ratio. This may be slightly different for 4:4:4 content and 4:2:2 content because the codecs are configured in terms of bits/pixel, rather than bits/subpixel. For 4:4:4 reordering, the image to be compressed may be ⅔ the width of the original image. Compression ratios are calculated as follows. Typically, systems have used bpc=8. However, newer display systems need to support higher bit depths (e.g. 10 bpc).

CR₄₄₄=[W*H*(3*bpc)]/[(⅔)*H*bpc]=4.5 bpc/bpp

CR₄₂₂=[W*H*(3*bpc)]/[W*H*bpc]=3 bpc/bpp

For example, if the source resolution is 1920×1080, 8 bpc, and the codec is configured at 6 bits/pixel, then the compression ratios may be:

CR₄₄₄=[1920*1080*(3*8)]/[(⅔)1920*1080*6]=4.5*8/6=6:1

CR₄₂₂=[1920*1080*(3*8)]/[(1920*1080*6]=3*8/6=4:1

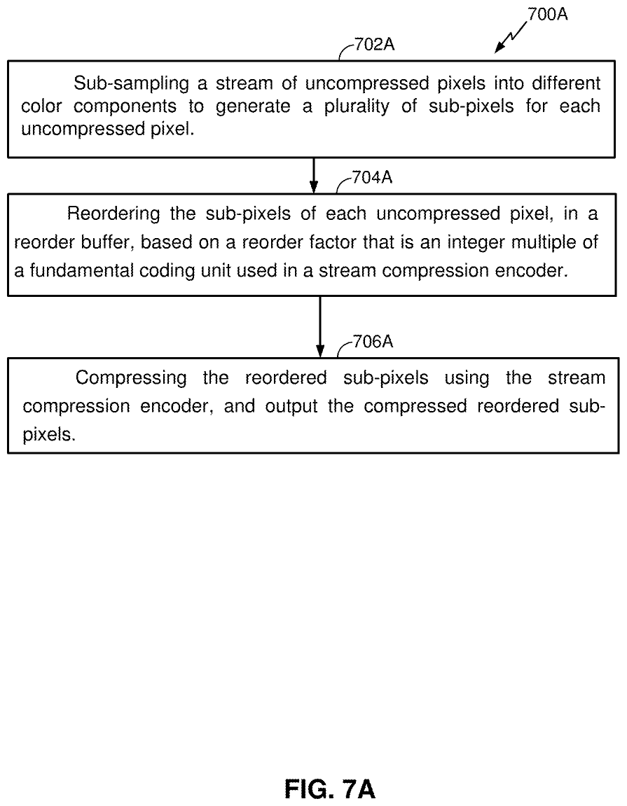

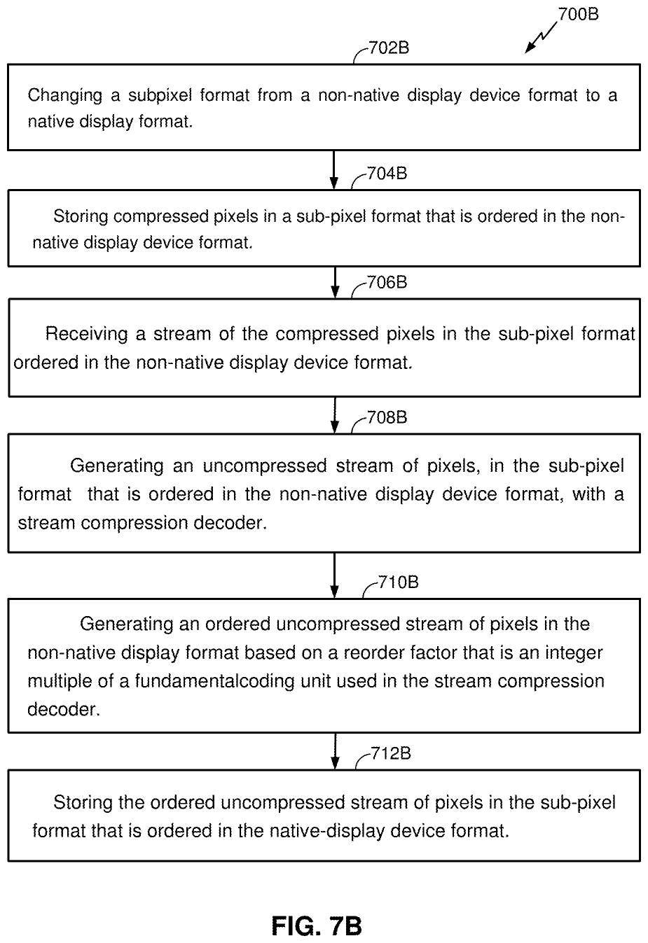

FIG. 7A illustrates a flowchart 700A of a process of a device that includes a reorder buffer based on a reorder factor in accordance with the techniques disclosed herein. The first step of the process is sub-sampling a stream of uncompressed pixels into different color components. The next step is generating a plurality of sub-pixels for each uncompressed pixel, wherein each sub-pixel is represented by one color component 702A. The following step is reordering the sub-pixels of each uncompressed pixel, in a reorder buffer, based on a reorder factor that is an integer multiple of a fundamental coding unit used in stream compression encoder 704A. The next step in the process is compressing the reordered sub-pixels using the stream compression encoder. Then the last step in the process is outputting the compressed reordered sub-pixels 706A.

FIG. 7B illustrates a flowchart 700B of a process of a device that changes a subpixel format from a non-native display device to a native display format in accordance with the techniques disclosed herein. The first step of the process in FIG. 7B is changing a subpixel format from a non-native display device format to a native display format 702B. The next step of the process is storing compressed pixels in a sub-pixel format that is ordered in the non-native display device format 704B. The next step in the process is receiving a stream of the compressed pixels in the sub-pixel format ordered in the non-native display device format 706B. Then the next step of the process it is generating an uncompressed stream of pixels, in the sub-pixel format that is ordered in the non-native display device format, with a stream compression decoder 708B. In addition, the flowchart shows the next step in the process as generating an ordered uncompressed stream of pixels in the sub-pixel format that is ordered in the non-native display format based on a reorder factor that is an integer multiple with a fundamental coding unit used in the stream compression decoder 710B. The last step in the process is storing the ordered uncompressed stream of pixels in the native display device format 712B.

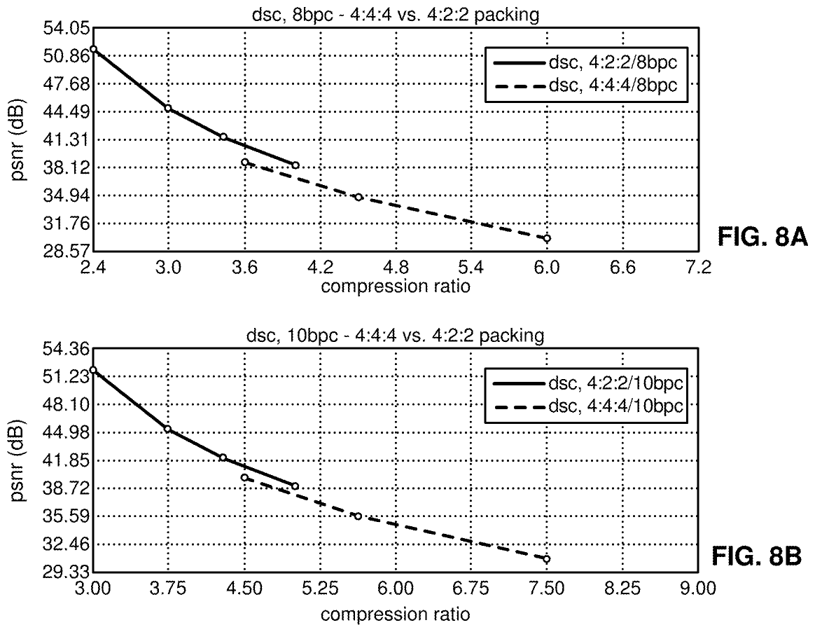

FIG. 8A illustrates the performance of 4:4:4 packing for the DSC codec using 8 bits per color (bpc). FIG. 8B illustrates the performance of 4:2:2 packing for the DSC codec using 10 bits per color (bpc). A codec is comprised of an encoder and a decoder.

FIG. 8A and FIG. 8B represent the performance for end to end compression and decompression. In general, 4:2:2 packing outperforms 4:4:4 packing due to the retained spatial consistency of the image (i.e. the lack of reordering picture data). However, there are operating points using 4:4:4 packing which retain sufficient visual quality as to offer an alternative to 4:2:2 packing. 4:4:4 packing at 10 bpp (CR=3.6) gives equivalent performance to 4:2:2 packing at 6 bpp (CR=4.0). This enables a use case for 4:4:4 packing of Pen Tile type data, especially for use with an older DSC encoder (i.e. DSC v1.1), which does not support native 4:2:2 mode.

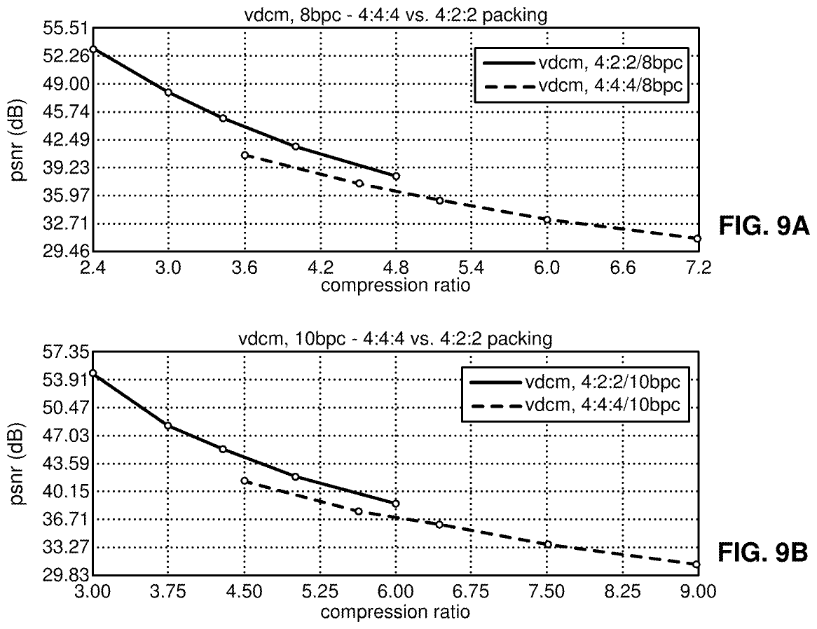

FIG. 9A illustrates the performance of 4:4:4 packing and 4:2:2 packing for the VDC-M codec using 8pbc. FIG. 9B illustrates the performance of the performance of 4:4:4 packing and 4:2:2 packing for the VDC-M codec using 10 bpc.

FIG. 9A and FIG. 9B represent the performance for end to end compression and decompression. The performance of 4:2:2 relative to 4:4:4 is even larger. This is due to certain optimization in the VDC-M 4:2:2 mode relative to DSC 4:2:2. Since 4:2:2 support is native in VDC-M v1.1 at no additional area, there is not a compelling reason to use 4:4:4 packing for Pen Tile type data for the VDC-M codec.

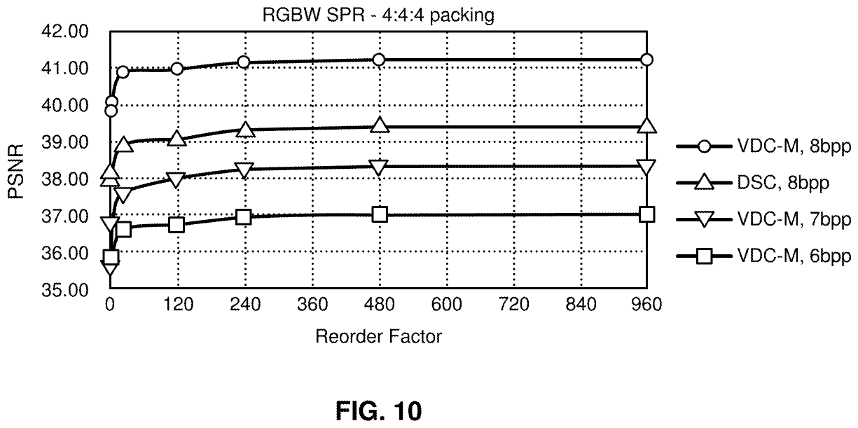

FIG. 10 illustrates for both display stream compression codecs, the performance for RGBW data, 4:4:4 packing. For RGBW data, 4:4:4 packing is appropriate, since all components have the same amount of data (i.e. 4:2:2 packing cannot be applied). The impact of the reorder factor on performance is significant since there is not an alternate packing strategy for RGBW data. A reorder buffer of moderate size (e.g. RF=24, RF=120) may allow for significantly improved codec performance relative to the base case (RF=1).

A person having ordinary skill in the art would recognize that depending on the example, certain acts or events of any of the methods described herein may be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used herein, the term “coding” refers to encoding or decoding. In embodiments using the various forms of coding, a video encoder may code by encoding a video bitstream using one or more of the above features and a video decoder may code by decoding such an encoded bitstream.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code, or instructions may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding or incorporated in a combined video encoder-decoder (CODEC).

The coding techniques discussed herein may be embodiment in an example video encoding and decoding system. A system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. In one example the source device includes a video source, a video encoder, and an output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general. The techniques may be applied to wireless and/or wired applications. In each case, the captured, pre-captured, or computer-generated video may be encoded by the video encoder. The encoded video information may then be output by output interface onto the computer-readable medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Particular implementations of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in a same value device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, “integrated” may include “manufactured or sold devices.” A device may be integrated if a user buys a package that bundles or includes the device as part of the package. In some descriptions, two devices may be coupled, but not necessarily integrated (e.g., different peripheral devices may not be integrated to a command device, but still may be “coupled”). Another example may be that any of the transceivers or antennas described herein that may be “coupled” to a processor, but not necessarily part of the package that includes a video device. Other examples may be inferred from the context disclosed herein, including this paragraph, when using the term “integrated.”

As used herein “a wireless” connection between devices may be based on various wireless technologies, such as Bluetooth, Wireless-Fidelity (Wi-Fi) or variants of Wi-Fi (e.g. Wi-Fi Direct. Devices may be “wirelessly connected” based on different cellular communication systems, such as, a Long-Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. In addition, when two devices are within line of sight, a “wireless connection” may also be based on other wireless technologies, such as ultrasound, infrared, pulse radio frequency electromagnetic energy, structured light, or directional of arrival techniques used in signal processing (e.g. audio signal processing or radio frequency processing).

As used herein A “and/or” B may mean that either “A and B,” or “A or B,” or both “A and B” and “A or B” are applicable or acceptable.

As used herein, a unit can include, for example, a special purpose hardwired circuitry, software and/or firmware in conjunction with programmable circuitry, or a combination thereof.

The term “computing device” is used generically herein to refer to any one or all of servers, personal computers, laptop computers, tablet computers, mobile devices, cellular telephones, smartbooks, ultrabooks, palm-top computers, personal data assistants (PDA' s), wireless electronic mail receivers, multimedia Internet-enabled cellular telephones, Global Positioning System (GPS) receivers, wireless gaming controllers, and similar electronic devices which include a programmable processor and circuitry for wirelessly sending and/or receiving information.

Various examples have been described. These and other examples are within the scope of the following claims.

1. A device configured to change a subpixel format from a non-native display device format to a native display format, the device comprising:
a buffer configured to store compressed pixels in a sub-pixel format that is ordered in the non-native display device format;
a processor, coupled to the buffer, configured to:
receive, from the buffer, a stream of the compressed pixels;
generate an uncompressed stream of the pixels with a stream compression decoder;
generate an ordered uncompressed stream of pixels in the native display device format by reordering the uncompressed stream of pixels in the sub-pixel format that is ordered in the non-native display format based on a reorder factor, the reorder factor being an integer multiple of a fundamental coding unit used in the stream compression decoder; and
output the ordered uncompressed stream of pixels in the native display device format; and
a reorder buffer, coupled to the processor, configured to store the ordered uncompressed pixels in the sub-pixel format that is ordered in the native display device format.

2. The device of claim 1, wherein the processor is configured to receive metadata that includes the reorder factor.

3. The device of claim 1, wherein the processor is configured to receive a set of bits, in a bitstream, representing the reorder factor.

4. The device of claim 1, further comprising a display device and a panel configured to display the ordered uncompressed pixels in the sub-pixel format that is ordered in the native display device format.

5. The device of claim 1, wherein the reorder buffer size is the reorder factor times the number of bits for each subpixel in the stream of uncompressed pixels.

6. The device of claim 1, wherein the fundamental coding unit is a group size of 3 subpixels for display stream compression (DSC) codec or a block size of 8×2 subpixels for a VESA display compression-M (VDC-M) codec.

7. The device of claim 1, further comprising a display device, wherein a display driver is integrated with the processor and the processor is configured to drive the display device.

8. A device comprising:
a memory configured to store compressed reordered sub-pixels; and
a processor configured to:
sub-sample a stream of uncompressed pixels into different color components to generate a plurality of sub-pixels for each uncompressed pixel;
reorder, the sub-pixels of each uncompressed pixel, in a reorder buffer, based on a reorder factor that is an integer multiple of a fundamental coding unit used in stream compression encoder;
compress the reordered sub-pixels using a stream compression encoder; and
store the compressed reordered sub-pixels to the memory.

9. The device of claim 8, wherein the processor is configured to output metadata that includes the reorder factor.

10. The device of claim 8, wherein the processor is configured to output a set of bits, in a bitstream, representing the reorder factor.

11. The device of claim 8, further comprising a transmitter configured to transmit the compressed reordered sub-pixels over an air-interface.

12. The device of claim 8, wherein the reorder buffer size is the reorder factor times the number of bits for each subpixel in the stream of uncompressed pixels.

13. The device of claim 8, wherein the fundamental coding unit is a group size of 3 subpixels for display stream compression (DSC) codec or a block size of 8×2 subpixels for a VESA display compression-M (VDC-M) codec.

14. The device of claim 8, further comprising a display device, wherein a display driver is integrated with the processor and the processor is configured to drive the display device.

15. A method comprising:
storing compressed pixels in a sub-pixel format that is ordered in a non-native display device format into a buffer;
receiving, from the buffer, a stream of the compressed pixels in the sub-pixel format ordered in the non-native display device format;
generating an uncompressed stream of pixels in the sub-pixel format that is
ordered in the non-native display device format with a stream compression decoder;
generating an ordered uncompressed stream of pixels in the native display device format by reordering the uncompressed stream of pixels in the sub-pixel format that is ordered in the non-native display format based on a reorder factor that is an integer multiple of a fundamental coding unit used in the stream compression decoder;
storing the ordered uncompressed stream of pixels in the sub-pixel format that is ordered in the native display device format.

16. The method of claim 15, further comprising receiving as metadata that includes the reorder factor.

17. The method of claim 15, further comprising receiving a set of bits, in a bitstream, representing the reorder factor.

18. The method of claim 15, further comprising displaying, on a panel of a display device, the ordered uncompressed pixels in the sub-pixel format that is ordered in the native-display device format.

19. The method of claim 15, wherein the fundamental coding unit is a group size of 3 subpixels for display stream compression (DSC) codec or a block size of 8×2 subpixels for a VESA display compression-M (VDC-M) codec.

20. A method comprising:
sub-sampling a stream of uncompressed pixels into different color components to generate a plurality of sub-pixels for each uncompressed pixel;
reordering the sub-pixels of each uncompressed pixel, in a reorder buffer, based on a reorder factor that is an integer multiple of a fundamental coding unit used in stream compression encoder; and
compressing the reordered sub-pixels using a stream compression encoder; and
outputting the compressed reordered sub-pixels.

21. The method of claim 20, further comprising outputting metadata that includes the reorder factor.

22. The method of claim 20, further comprising outputting a set of bits, in a bitstream, representing the reorder factor.
